(19) United States
(12) Patent Application Publication
(10) Pub. No.: US 2006/0000849 A1
(43) Pub. Date: Jan. 5, 2006

(54) Metering system having a portable controller

(76) Inventors: David G. Simmons, Ft. Myers, FL (US); Richard A. Beckenhauer, Cape Coral, FL (US); Dean Barry McDaniel, San Diego, CA (US); Terry David Schevker, San Diego, CA (US); Stuart Alan Tenenbaum, San Diego, CA (US); Bradley James Padilla, La Mesa, CA (US); John Cantril McCosh, San Diego, CA (US)

Correspondence Address: HODGSON RUSS LLP, ONE M & T PLAZA, SUITE 2000, BUFFALO, NY, 14203-2391, US

(21) Appl. No.: 11/110,160

(22) Filed: Apr. 20, 2005

Related U.S. Application Data
(60) Provisional application No. 60/563,668, filed on Apr. 20, 2004.

(51) Int. Cl. B67B 7/00; G01F 11/00

(52) U.S. Cl. 222/1

(57) ABSTRACT

A metering system according to the invention may include a portable controller, a metering pump in communication with the portable controller and capable of receiving signals from the portable controller, and at least one process sensor in communication with the portable controller and capable of sending information signals to the portable controller. A method according to the invention may include providing a portable controller, providing a metering pump in communication with the portable controller, providing a process sensor that is capable of sensing an aspect of the process, and is in communication with the portable controller, communicating process information from the process sensor to the portable controller, communicating a control signal from the portable controller to the metering pump, and dispensing the substance from the pump to the process.

### CROSS-REFERENCE TO RELATED APPLICATION

This application claims the benefit of priority to U.S. provisional patent application Ser. No. 60/563,668, filed on Apr. 20, 2004.

### FIELD OF THE INVENTION

The present invention relates to metering pumps, and the systems that control metering pumps.

### BACKGROUND OF THE INVENTION

Metering pumps are used to accurately dispense a substance. For example, in industrial processes, a metering pump may be used to add a small amount of chemical to a large amount of liquid so the chemical has a desired effect on the industrial process. Further, since the cost of the chemical may be high, a metering system may be used to prevent over-use of the chemical.

There are many types of industrial processes which use metering pumps. Each industrial process may have requirements for a metering pump that are unique to that process, or that are common only to some of the many types of industrial processes. Consequently, suppliers of metering pump systems have many types of metering systems to accommodate the many types of industrial processes. As a result, metering system suppliers must manufacture and/or store a large number of different metering systems, have sales representatives who are knowledgeable about the large number of different metering systems, and have an engineering staff capable of designing and recommending proper servicing techniques for the large number of metering systems. As a result, the cost of a metering system is higher than if the number of types of metering systems was fewer.

Some metering systems include a metering pump and an onboard computer (a “pump-computer”), which may be attached to the pump base. The pump-computer is programmed to control the metering pump so that a desired amount of a substance is provided via the pump to a process. A personal digital assistant (“PDA”) may be used to provide a user interface with the pump-computer. The PDA may be used to download information from the pump-computer to the PDA. The PDA may also be used to upload information from the PDA to the pump-computer, for example, to alter the manner in which the pump-computer controls the metering pump.

The prior art systems allow the pump-computer to be reprogrammed via the PDA so as to change how the pump-computer controls the metering pump. In these systems, the PDA serves merely as a user interface. As such, programming changes to the pump-computer must be made at the pump-computer location.

### SUMMARY OF THE INVENTION

The present invention may be embodied as a metering system. Such a metering system may have (1) a portable controller, (2) a metering pump in communication with the portable controller and capable of receiving signals from the portable controller, and (3) at least one process sensor in communication with the portable controller and capable of sending information signals to the portable controller. The portable controller may have one or more of the following: (1) a microprocessor, (2) a monitor, (3) memory, and (4) software for enabling the microprocessor to execute desired activities. The portable controller may be a PDA, capable of being held in a person's hand.

The present invention may be embodied as a method of dispensing a substance to a process. In such a method, (1) a portable controller may be provided, (2) a metering pump may be provided in communication with the portable controller, (3) a process sensor may be provided that is capable of sensing an aspect of the process, and is in communication with the portable controller, (4) process information may be communicated from the process sensor to the portable controller, (5) control information may be communicated from the portable controller to the metering pump, and (6) the substance may be dispensed from the pump to the process. The portable controller may be programmed at a remote location and shipped to the metering pump location for use in the metering system.

### BRIEF DESCRIPTION OF THE DRAWINGS

For a fuller understanding of the nature and objects of the invention, reference should be made to the accompanying drawings and the subsequent description. Briefly, the drawings are:

FIG. 1, which is a schematic representation of a system according to the invention.

FIG. 2, which depicts a portable controller and a housing according to the invention.

FIG. 3, which is a flow chart depicting a method according to the invention.

### FURTHER DESCRIPTION OF THE INVENTION

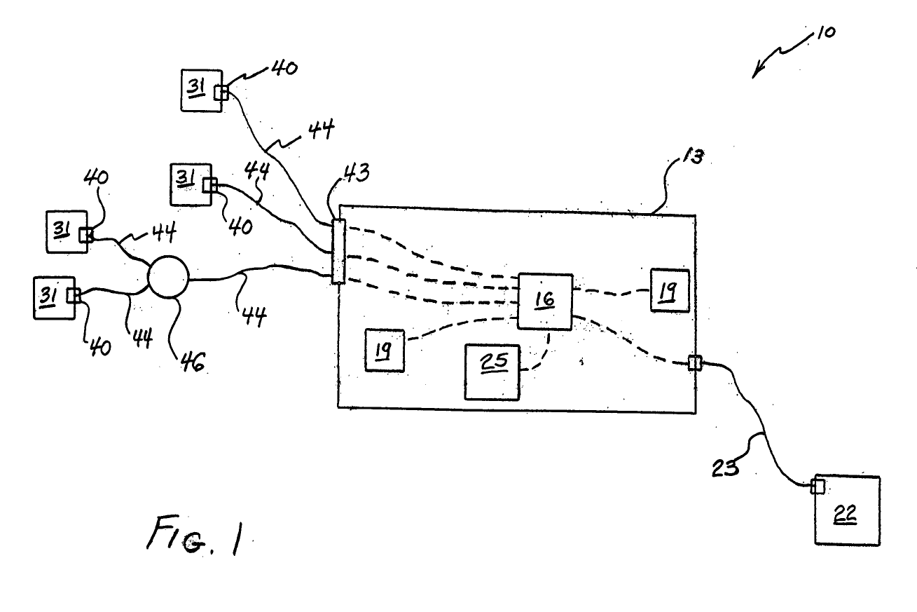

FIG. 1 depicts an example of a metering system 10 according to the invention. In FIG. 1, there is shown a portable controller 13 having a microprocessor 16. The portable controller 13 may be programmed to receive signals and send signals. In one embodiment of the invention, the portable controller 13 is a PDA, such as a Dell Axim™, available from Dell Inc. of Austin, Tex. The portability afforded by the portable controller 13 allows the portable controller 13 to be removed from the metering system 10 and sent to a central facility for reprogramming and/or repair. When one portable controller 13 is sent for reprogramming, a second portable controller 13 may be connected to the metering system 10, so that the metering system 10 will operate while the first portable controller 13 is reprogrammed and/or repaired.

The portable controller 13 may have one or more memories 19 for storing information. For example, memories 19 may be provided to store one or more of the following: (1) process operational parameters, such as acceptable high and low conductivity levels, (2) process performance information, such as conductivity of a process at particular times, (3) information about control signals sent from the portable controller 13 to a metering pump 22, which may be used to determine whether the portable controller 13 is reacting properly to process performance information based on the process operational parameters.

The portable controller 13 may have a built-in monitor 25. The monitor 25 may be capable of displaying the process operational parameters, process performance information, and/or the information about control signals sent from the portable controller 13 to the metering pump 22. The monitor 25 may be used to reprogram the portable controller 13 by providing a graphical user interface that allows a person to select desired operational parameters for the metering system 10.

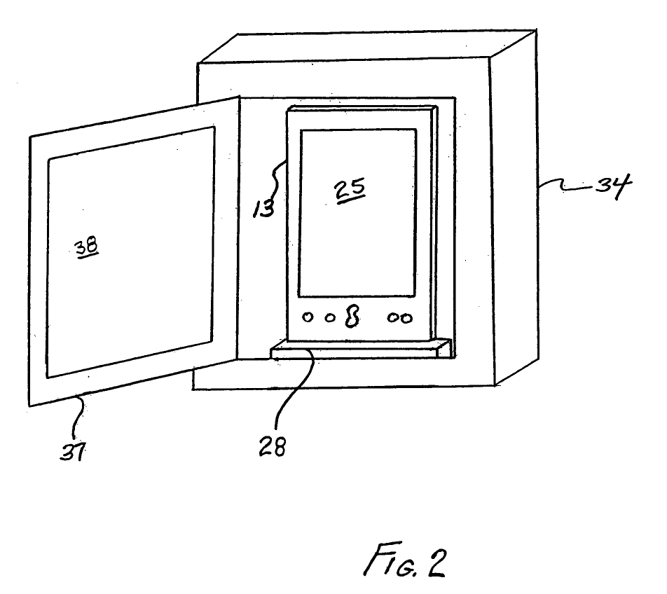

FIG. 2 depicts a portable controller 13 and a cradle 28 in which the portable controller 13 may be placed. The cradle 28 may provide electric power to the portable controller 13, and may provide jacks where signals may be received from a process sensor 31 and/or signals may be sent to the metering pump 22.

FIG. 2 also depicts a portion of the metering system 10 which includes a housing 34. The portable controller 13 may be received in the housing 34. The housing 34 may protect the portable controller 13 from an operating environment. For example, the housing 34 may protect the portable controller 13 from dirt, chemicals or radiant energy that might adversely impact the portable controller 13. The housing 34 may include a hinged door 37, which allows easy access to the portable controller 13. The door 37 may have a translucent portion 38 through which the portable controller 13 may be viewed.

Referring to FIG. 1, the metering system 10 may include the metering pump 22 that is in communication with the portable controller 13 and capable of receiving signals from the portable controller 13. The signals from the portable controller 13 to the metering pump 22 may be carried via a wired or wireless communication channel 23. The metering pump 22 may be able to effect a change in an aspect of a process. For example, the metering pump 22 may be able to add a chemical to the process. One such application of a metering pump 22 might be to add a corrosion inhibitor to a crude oil distillate in order to protect a heat exchanger from corrosive properties of the distillate.

The metering system 10 may include at least one process sensor 31 in communication with the portable controller 13. The process sensor 31 may be capable of sending information signals to the portable controller 13, the information signals being related to an aspect of the process. For example, the process sensor 31 might measure the conductivity of a liquid, and send the information signal to the portable controller 13 in order to inform the portable controller 13 about the conductivity of the liquid. The portable controller 13 would then use the conductivity information to determine whether a metering pump should inject a chemical into the liquid in order to alter the conductivity of the liquid. The process sensor 31 may provide digital or analog information to the portable controller 13. The process sensor 31 may include a flash memory to allow software changes, upgrades and fixes to be easily implemented.

More than one process sensor 31 may be bundled into a multi-sensor device. In this fashion, a metering system manufacturer may supply a single device that includes all the sensors normally used by, a particular type of facility. For example, to satisfy the needs of a cooling tower facility, a conductivity sensor, oxidation-reduction potential sensor, pH sensor and a temperature sensor may be placed in a single housing, and wires from each of the sensors may extend through a single sheath to the portable controller 13. Since most metering systems deployed to service a cooling tower require these sensors 31, bundling these sensors 31 into the multi-sensor device may make supplying and installing the metering system 10 easier and cheaper. The wires extending from the bundled sensors 31 and/or fittings attached to the wires may be color coded to indicate which sensor 31 is associated with a particular wire. Further, the multi-sensor housing may be color coded so one multi-sensor device may be easily distinguished from another multi-sensor device.

The process sensor 31 may be capable of sending an identification signal to the portable controller 13 identifying the process sensor 31 as being a particular type of process sensor 31. In such a system, when the process sensor 31 is added to the metering system 10, the process sensor 31 may send the identification signal to allow the portable controller 13 to know what type of process information will be provided and the form in which that information will be provided. For example, the process sensor 31 may provide a code that can be matched to a table of codes stored in a memory 19 of the portable controller 13. Once a match is found in the table, the portable controller 13 may be able to access information necessary to interpret the information signal from process sensor 31. In this manner, the portable controller 13 will be able to receive the information signal from the process sensor 31 and utilize the information to provide a corresponding signal to the metering pump 22, and thereby effect a change to the process.

The process sensor 31 may include a sensor-transmitter 40 and the portable controller 13 may include a controller-receiver 43. Communicating the information signals from the sensor-transmitter 40 to the controller-receiver 43 may be accomplished via a wireless or wired communication system, which may include the sensor-transmitter 40, the controller-receiver 43 and one or more communication channels 44. The controller-receiver 43 may be part of the cradle 28 in which the portable controller 13 resides. The information signals may be sent via a standard or proprietary communication protocol. For example, the information signals may be sent via a universal serial bus. Further, the information signals may be encrypted to prevent others from discovering the information being carried by the information signal.

The metering system 10 may include a communications hub 46 via which at least two process sensors 31 may communicate with the portable controller 13. The communications hub 46 may include electronics to boost a signal from a process sensor 31 and/or multiplex signals from two or more process sensors 31.

The portable controller 13 may include a memory 19 in which software may be stored. The software may be used to program the microprocessor 16 to execute desired activities. The microprocessor 16 may be programmed in an object oriented manner. The microprocessor 16 may execute a main program which periodically “passes” operational parameters to one or more code modules, and receives from the code modules one or more results. For example, the main program may retrieve from the memory the process operational parameters, such as water temperature threshold and water conductivity threshold. These operational parameters might then be “passed” to a first code module. The first code module might then determine a time when the metering pump 22 should dispense a chemical. The first code module may pass the determined time back to the main program, which then passes the current time and the determined time to a second code module. The second code module may then perform a comparison on the current time and the determined time to decide whether the determined time has been reached. If the determined time has been reached, the second module may set a flag such that upon a next check of the flag, the main program causes the microprocessor 16 to send a control signal to the metering pump 22. Upon receiving the pump signal, the metering pump 22 would then dispense a quantity of water treatment chemical. In a similar manner, the program might also include one or more code modules to determine a quantity of chemical to be dispensed using operation parameters and information signals.

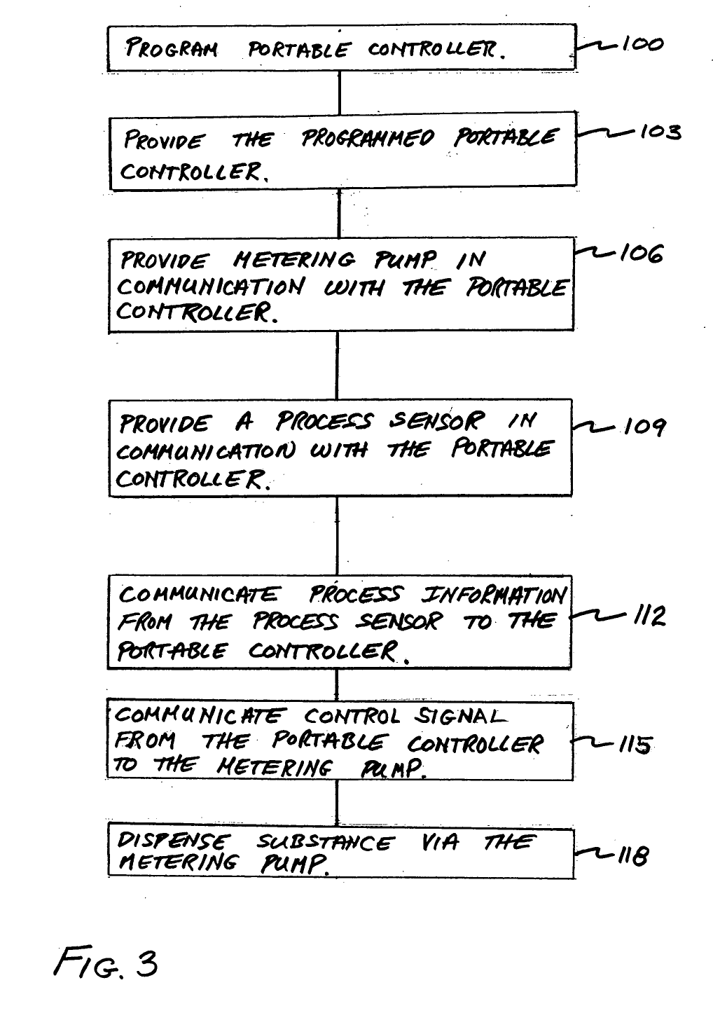

FIG. 3 depicts a method according to the invention. In the method, a substance, such as a chemical, may be dispensed to the process. A portable controller may be programmed 100, for example, at a location distant from the process, according to specifications provided by an engineer. The programmed portable-controller may then be provided 103 to a facility where the process is located. For example, the programmed portable controller may be mailed to the facility.

A metering pump may be provided 106 in communication with the portable controller. To accomplish this, the metering pump may be provided in communication with a cradle, and the portable controller may be placed in the cradle so as to allow the portable controller to be in communication with the metering pump. A process sensor, which is capable of sensing an aspect of the process, may be provided 109 in communication with the portable controller, for example, via the cradle. Process information may be communicated 112 from the process sensor to the portable controller, and a corresponding control signal may be communicated 115 from the portable controller to the metering pump. The parameters of the control signal may be determined by the controller using software designed for analyzing the process information and selecting an appropriate corresponding control signal. The control signal may cause the metering pump to dispense 118 the substance.

The method may be carried out by storing operational parameters of the process in the portable controller, and the portable controller may use these to determine whether the substance should be dispensed to the process.

The method may be carried out to store process information provided by the process sensor. The process information may be stored in the portable controller. The portable controller may be removed from the metering system and delivered to an engineer for use in determining whether the substance delivered by the metering pump is having a desired effect on the process. The engineer may be located remotely from the metering system. When the portable controller is removed, a substitute portable controller may be used with the metering system.

When two portable controllers are used, one being the substitute portable controller, the metering system may be easily and cheaply installed. Complex communication systems are not required, and the portable controllers can be easily reprogrammed at a central facility, which may be far away from the metering system, thereby reducing costs normally associated with metering systems.

U.S. Patent Application No. 60/563,668 includes descriptions of other embodiments according to the invention. U.S. Patent Application No. 60/563,668 is hereby incorporated into this patent application by this reference.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A metering system comprising:
a portable controller having a microprocessor capable of receiving signals and sending signals;
a metering pump in communication with the portable controller and capable of receiving signals from the portable controller, the metering pump being able to effect a change in an aspect of a process; and
at least one process sensor in communication with the portable controller and capable of sending information signals to the portable controller, the signals being related to the aspect of the process.

2. The system of claim 1, further comprising a sensor-transmitter and a controller-receiver, wherein communication from the process sensor to the portable controller is accomplished via a wireless communication system which includes the sensor-transmitter and the controller-receiver.

3. The system of claim 2 wherein communication from the sensor-transmitter to the controller-receiver is encrypted.

4. The system of claim 1, further comprising a sensor-transmitter and a controller-receiver, wherein communication from the process sensor to the portable controller is accomplished via a wired communication system which includes the sensor-transmitter and the controller-receiver.

5. The system of claim 4, wherein communication from the sensor-transmitter to the controller-receiver is via a universal serial bus.

6. The system of claim 1 further comprising a communications hub via which at least two process sensors may communicate with the portable controller.

7. The system of claim 1, wherein the portable controller also has a memory in which operational parameters of the process may be stored.

8. The system of claim 7, wherein the portable controller also has a monitor capable of displaying the operational parameters.

9. The system of claim 1, wherein the portable controller also has a memory in which process performance information may be stored.

10. The system of claim 1, wherein the portable controller also has a monitor capable of displaying the process performance information.

11. The system of claim 1, wherein the microprocessor is programmed in an object oriented manner.

12. The system of claim 1, wherein the process sensor provides digital or analog information to the portable controller.

13. The system of claim 1, wherein the at least one process sensor is a multi-sensor device in which at least two process sensors are housed together as a single device.

14. The system of claim 1 wherein the process sensor is capable of sending an information signal to the portable controller identifying the process sensor as being a particular type of process sensor.

15. The system of claim 1 further comprising a cradle in which the portable controller may be placed to receive signals from the process sensor and send signals to the metering pump.

16. The system of claim 1 further comprising a housing capable of receiving the portable controller and protecting the portable controller from an operating environment.

17. The system of claim 16 further comprising a door hingedly attached to the housing and capable of allowing access to the portable controller.

18. The system of claim 17 wherein at least a portion of the door is translucent.

19. A method of dispensing a substance to a process comprising:
providing a portable controller;
providing a metering pump in communication with the portable controller;
providing a process sensor capable of sensing an aspect of the process, the sensor being in communication with the portable controller;
communicating process information from the process sensor to the portable controller;
communicating a control signal from the portable controller to the metering pump; and
dispensing the substance from the pump to the process.

20. The method of claim 19 further comprising storing operational parameters of the process in the portable controller.

21. The method of claim 19, further comprising storing process performance information in the portable controller.

22. The method of claim 19 further comprising delivering the portable controller to a remote facility for use in determining whether the substance is having a desired effect on the process.
